(19) United States
(12) Patent Application Publication
(10) Pub. No.: US 2012/0176907 A1
(43) Pub. Date: Jul. 12, 2012

(54) TESTING APPARATUS WITH A PROPAGATION SIMULATOR FOR A WIRELESS ACCESS DEVICE AND METHOD

(76) Inventors: Abraham Hartenstein, Chatsworth, CA (US); Steven Krattiger, Northridge, CA (US)

(21) Appl. No.: 12/987,054

(22) Filed: Jan. 7, 2011

(51) Int. Cl. H04L 12/26

(52) U.S. Cl. 370/241

(57) ABSTRACT

An apparatus for testing the communication between a wireless access device and a wireless device in communication with the wireless access device is provided. The apparatus includes a housing having a first interior chamber adapted to receive a wireless access device and a second interior chamber adapted to receive a wireless device. The apparatus also includes a simulator device for simulating one or more propagation scenarios between the wireless access device and the wireless device. Probes are positioned in the first interior chamber and the second interior chamber. The probes are coupled to the simulator device and are adapted to exchange signals between the wireless access device and the wireless device.

### BACKGROUND

1. Field of the Invention

This invention relates to testing apparatuses for wireless communication devices and more particularly to apparatuses and methods that use simulators for testing communications between a wireless device and a wireless access device.

2. Description of Related Art

The use of wireless communication devices for data networking continues to grow at a rapid pace. Data networks that use “WiFi” (“Wireless Fidelity”), also known as “Wi-Fi,” are relatively easy to install, convenient to use, and supported by the IEEE 802.11 standard. WiFi data networks also provide performance that makes WiFi a suitable alternative to a wired data network for many business and home users.

WiFi networks operate by employing wireless access points that provide users, having wireless (or “client”) devices in proximity to the access point, with access to varying types of data networks such as, for example, an Ethernet network or the Internet. The wireless access points include a radio that operates according to the standards specified in different sections of the IEEE 802.11 specification. Generally, radios in the access points communicate with client devices by utilizing omni-directional antennas that allow the radios to communicate with client devices in any direction. The access points are then connected (by hardwired connections) to a data network system that completes the access of the client device to the data network.

High-end wireless devices recently developed include multiple radios to improve bandwidth, user density, signal strength, coverage area, signal management and load balancing. These new wireless devices may use spatial multiplexing to increase data transmission rates by using multiple antennas to simultaneously send and receive data. Spatial multiplexing involves dividing a data stream into multiple data signals and transmitting the data signals over multiple transmitting antennas operating on the same channel. A receiver receives the multiple data signals at multiple receiving antennas and recombines the data signals to obtain the original data stream.

Wireless implementations that use multiple antennas at the transmitter and the receiver may be referred to as Multiple-In/Multiple-Out (MIMO) implementations or environments. Accordingly, MIMO implementations may be described by the number of transmitting antennas and the number of receiving antennas. For example, a MIMO implementation having three transmitting antennas and three receiving antennas may be referred to as a 3×3 MIMO implementation. Some MIMO implementations may include one more receiving antenna than transmitting antenna. Thus, a MIMO implementation having two transmitting antennas and three receiving antennas may be referred to as a 2×3 MIMO implementation.

The development of MIMO implementations has resulted in the need for testing apparatuses to test wireless communication hardware during development. Known testing apparatuses may test wireless communication devices in a wired fashion. As a result, to perform certain tests, it may be necessary to bypass the wireless antennas of the wireless communication devices under test. Further, certain wireless tests may be performed in an open air environment. Open air tests may simulate attenuation and phase delay between wireless devices. However, interference from other transmissions propagating through the open air environment may affect and introduce uncertainty into the open air tests.

Thus, there is a need for a testing system that provides an isolated propagation environment as well as the ability to simulate open air conditions between two wireless devices using a MIMO implementation.

### SUMMARY

An apparatus for testing the communication between a wireless access device and a wireless device in communication with the wireless access device is provided. The apparatus includes a housing having a first interior chamber adapted to receive a wireless access device and a second interior chamber adapted to receive a wireless device. The apparatus also includes a simulator device for simulating one or more propagation scenarios between the wireless access device and the wireless device. Probes are positioned in the first interior chamber and the second interior chamber. The probes are coupled to the simulator device and are adapted to exchange signals between the wireless access device and the wireless device.

A method of testing the communication between a wireless access device and a wireless device in communication with the wireless access device is also provided. A wireless access device is placed into a first interior chamber of a housing and a wireless device is placed into a second interior chamber of the housing. The wireless access device and the wireless device are each placed adjacent to respective probes. The probes are adapted to receive signals from the wireless access device and the wireless device respectively. When signals are exchanged between the wireless access device and the wireless device, a propagation scenario is simulated.

### BRIEF DESCRIPTION OF THE DRAWINGS

FIG. 1 is a side cross-sectional view of an example testing apparatus with a propagation simulator for a wireless access device.

FIG. 2 is a perspective view of an example probe that may be used with the testing apparatus of FIG. 1.

FIG. 3 is a side view of a portion of the probe of FIG. 2.

FIG. 4 is a schematic view of an attenuation and phase shift simulator device that may be used with the testing apparatus of FIG. 1.

### DETAILED DESCRIPTION

In the following description of the preferred embodiment, reference is made to the accompanying drawings that form a part hereof, and which show, by way of illustration, a specific embodiment in which the invention may be practiced. Other embodiments may be utilized and structural changes may be made without departing from the scope of the present invention.

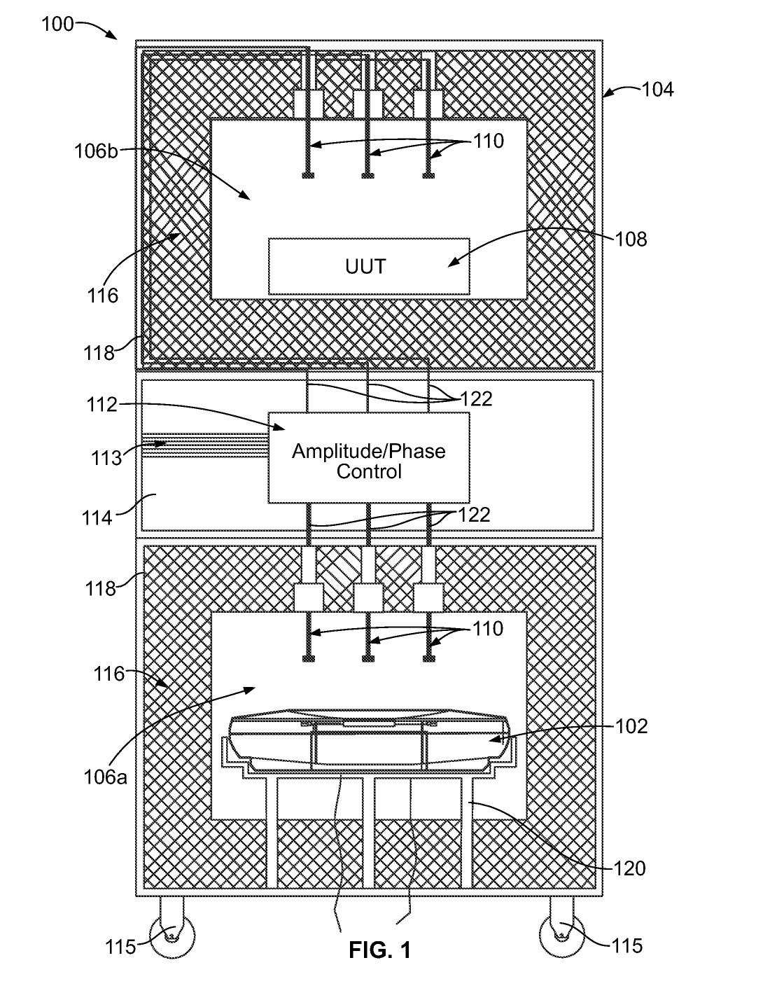

A testing apparatus with a propagation simulator for a wireless access device is described herein. Referring to FIG. 1, the testing system 100 for a wireless access device 102 includes a housing 104 having two interior chambers 106a-b. The first interior chamber 106a encloses a wireless access device 102. The wireless access device 102 provides users, having wireless (or “client”) devices in proximity to the access device, with access to varying types of data networks such as, for example, an Ethernet network or the Internet. The second interior chamber 106b encloses a wireless device 108 capable of accessing a wireless network such as, for example, a laptop computer, a tablet computer, a video game console, a smartphone, a personal digital assistant (PDA), and the like. When the wireless device 108 is undergoing testing, the wireless device may be referred to as the unit under test.

The testing system 100 also includes one or more probes 110 inserted into each chamber 106a-b. The probes 110 exchange wireless transmissions between the wireless access device 102 and the unit under test 108. Additionally, the probes 110 are coupled with a propagation simulator 112. Accordingly, transmissions between the wireless access device 102 and the unit under test 108 are routed through the propagation simulator 112 during testing.

The propagation simulator 112 may be used to simulate various conditions of WiFi communication. Interface cables 113 may couple the propagation simulator 112 to an external computing device (not shown), which may be used to control the propagation simulator as discussed further below. The propagation simulator may be enclosed within another chamber 114 of the housing 104 or otherwise attached to the housing of the testing system 100. The housing 104 of the testing system 100 may further include a set of wheels 115 for repositioning the system in a lab or testing environment.

Still referring to FIG. 1, the testing system 100 in the example shown includes two isolated chambers 106a-b, which respectively enclose a wireless access device 102 and a unit under test 108. Each chamber 106a-b may include a service door (not shown) for providing access to the chambers. The chambers 106a-b may also include a door frame (not shown) that interfaces with the service door when the chambers are in a closed position. An electromagnetic interference (EMI) gasket (not shown) may be placed around the perimeter of the door frame as well as the perimeter of the service door in order to minimize leakage from the chambers, crosstalk between the chambers, or other kinds of wireless interference.

The chambers 106a-b may also include a broadband foam absorber 116 applied to the interior walls 118 of each chamber. As seen in FIG. 1, the broadband foam absorber 116 is applied to all of the interior walls of each chamber 106a-b. The broadband foam absorber 116 may have one or more layers of polyurethane foam treated with carbon. In this example, the broadband foam absorbers may have three layers, and each layer may have a different carbon density, which provides a conductivity gradient. A suitable broadband foam absorber may be available from Emerson & Cuming Microwave Products as product designation ECCOSORB® AN-79. Alternative broadband absorbing materials and structures may selectively be employed.

As mentioned above, chamber 106a encloses a wireless access device 102, and chamber 106b encloses a unit under test 108. As shown in FIG. 1, the wireless access device may be placed onto a mounting fixture 120 that positions the wireless access device near the center of the chamber 106a. The mounting fixture 120 may be keyed to ensure placement of the wireless access device 102 in a particular orientation. For example, the wireless access device 102 may include one or more recesses (not shown) in the body of the device, and the mounting fixture 120 may include one or more projections (not shown) that correspond to the recesses of the wireless access device. Accordingly, an operator may ensure proper placement of the wireless access device 102 on the mounting fixture 120 by aligning the recesses and the projections and lowering the wireless access device onto the mounting fixture so that the projections are received within the recesses.

Further, as seen in FIG. 1, the chamber 106b enclosing the unit under test 108 is positioned above the chamber 106a enclosing the wireless access device 102. Those skilled in the art will appreciate that other arrangements for the chambers, such as side-by-side and front-to-back arrangements of the chambers 106a-b, may also be employed.

FIG. 1 also illustrates multiple probes 110 positioned within each chamber. The probes 110 operate to exchange transmissions between the wireless access device 102 and the unit under test 108. As mentioned above, the chambers 106a-b are isolated from one another as well as from the environment outside the housing in order to ensure that transmissions propagate through the probes 110. The probes are routed the propagation simulator 112 via coaxial cables 122. The coaxial cables 122 may be, for example, SubMiniature Version A (SMA) cable assemblies.

The probes 110 are configured to operate in the WiFi frequence band, i.e., between 1.5 GHz and 8 GHz. For example, the probes 110 may be used to test wireless access devices and wireless devices conforming to the IEEE 802.11a, 802.11b, and 802.11g standards. Further, the probes 110 in the example testing system 100 are designed to accommodate MIMO implementations of wireless architectures, e.g., 2×3 implementations or 3×3 implementations.

The example testing system 100 shown in FIG. 1 is a 3×3 MIMO implementation. Each chamber 106a-b includes a set of three probes 110 positioned above the wireless access device 102 and the unit under test 108 respectively. Further, each probe 110 in one chamber is coupled to a corresponding probe in the other chamber. For example, the left probe 110 of the chamber 106a for the wireless access device 102 is coupled via a coaxial cable 112 to the left probe 110 of the chamber 106b for the unit under test 108. Similarly, the middle and right probes 110 of the chamber 106a for the wireless access device 102 are respectively coupled to the middle and right probes 110 of the chamber 106b for the unit under test 108.

In order to maximize coupling between the wireless access device 102 and the unit under test 108, the probes 110 are adjustable in height. Those skilled in the art will recognize that signal strength may improve as the probe is positioned closer to the wireless access device 102 and/or the unit under test 108. Accordingly, the probes 110 in this example may operate in the near field zone of the wireless access device 102 and the unit under test 108. Those skilled in the art will understand that the near field zone is the area less than one wavelength from the front of an antenna. Because the probes 110 operate in the near field zone, the probe is less sensitive to interference from, for example, reflections or other antennas nearby. However, those skilled in the art will appreciate that mutual coupling effects between an antenna and the probes 110 may occur if the probe is positioned too close to the antenna. Thus, those skilled in the art will understand that the optimum distance between an antenna and the probes 110 may depend on, for example, the testing environment and/or the characteristics of the antenna and the probe. However, in some situations, for example, a suitable distance between a probe 110 and a wireless access device 102 or unit under test 108 may be around 1″ (one inch) to 1.125″ (one and one-eighth inch).

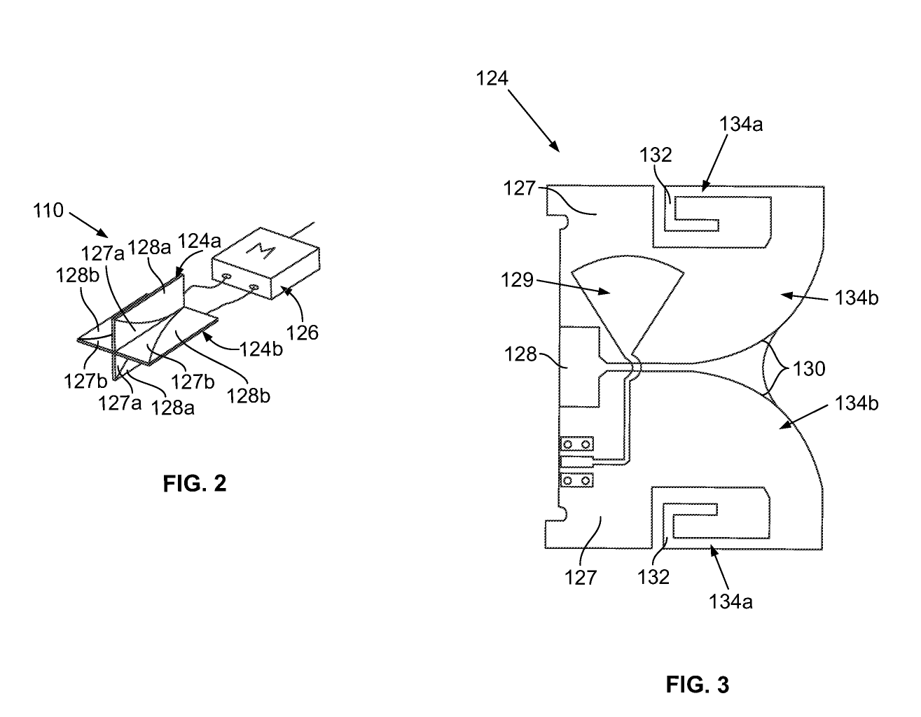

Referring now to FIG. 2, a probe 110 that may be used with the testing system 100 is shown. In addition to operating in the WiFi frequency bands, the probes 110 are also designed to maximize the amount of electromagnetic energy collected from the wireless access device 102 and the unit under test 110. The probes 110 may be dual polarized since the polarization of the electromagnetic energy of the transmissions from the devices 102, 110 may be rotated, diffracted, and the like. Dual polarization of the probe 110 may be provided by including crossed and interleaved antennas 124a-b such that the antennas are positioned orthogonal relative to one another as shown in FIG. 2.

Additionally, the probe 110 may be connected to a broadband power combiner 126. As discussed above, the probes 110 are designed to maximize the amount of energy collected from the antennas of a wireless access device 102 or a unit under test 108 in a MIMO implementation. The power combiner 126 may combine the power signals from each probe antenna 124a-b into a single power signal representing the total amount of energy collected from one antenna of wireless access device 102 or unit under test 108. For example, the vertical probe antenna 124a may collect 62% (sixty-two percent) of the energy emitted from a one antenna of a unit under test 108 in a MIMO implementation. Similarly, the horizontal probe antenna 124b may collect 37% (thirty-seven percent) of the energy emitted from the antenna of the unit under test 108. The power combiner 126 may combine the signals from each probe antenna 124a-b into a signal representing the overall amount of energy collected from one antenna of the unit under test 108, 99% (ninety-nine percent) in this example. A suitable power combiner may be, for example, a Wilkinson power divider/combiner. Further, the probe may include a Wilkinson power divider/combiner printed on the probe antennas 124a-b.

Each probe antenna 124a-b may be, for example, a patch antenna as shown in FIG. 2. Those skilled in the art will understand that a patch antenna is an antenna in which a metal patch 127a-b is suspended on, over, or within a dielectric substrate 128a-b. A feedline 129 (FIG. 3) such as, for example, a microstrip may carry the RF signals to and from the antenna 124.

Further, the example probe antennas 124a-b may also be a notch antenna as shown in FIG. 2 and FIG. 3. Those skilled in the art will understand that a notch antenna is an antenna in which the radiation pattern is determined by the size and/or shape of a notch (also referred to as a slot) formed by the antenna. Further, radiation occurs at the notch as a result of the microstrip 129 crossing the notch as shown by way of example in FIG. 3. The notch 130 of the probe antenna 124 in the example shown has a tapered and flared shape. Those skilled in the art will recognize that this type of antenna may be referred to as a tapered slot antenna, a Vivaldi notch antenna, a Klopenstein notch antenna, or a Tschebichev notch antenna. The tapered and flared shape of the notch 130 allows the probe antenna 124 to operate proximate to the 3.5 GHz and the 6 GHz frequency bands.

With reference to FIG. 3, the probe antenna 124, in the example shown, has spiraled antenna arms 132. The spiraled antenna arms 132 allow the probe antenna to operate proximate to 2.4-2.5 GHz frequency bands. By including 2.4 GHz radiating sections 134a and 5 GHz radiating sections 134b, the probe may exchange radio signals between wireless access devices and wireless devices conforming to the IEEE 802.11a, 802.11b, and 802.11g standards. As mentioned above, the crossed and interleaved Vivaldi notch antennas provide dual polarization maximizing the amount of emitted energy collected.

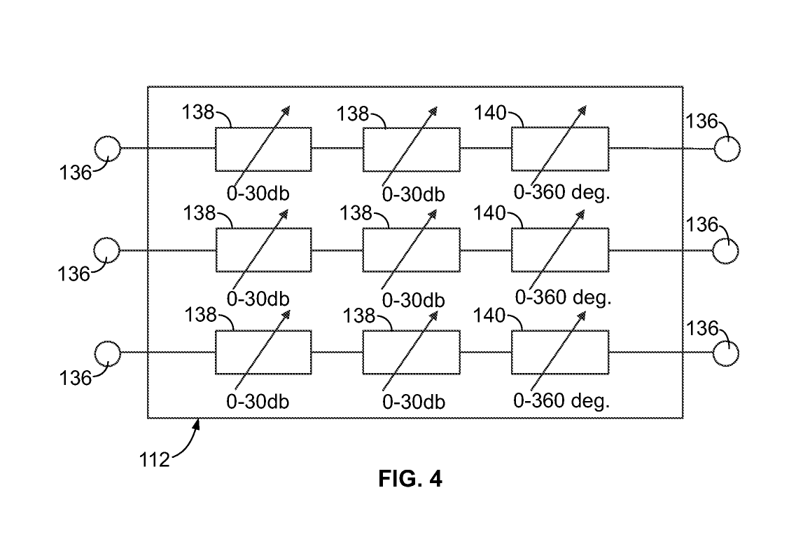

As mentioned above, a propagation simulator 112 is positioned between corresponding probes 110 such that the signals from each probe pass through the propagation simulator during transmission. FIG. 4 is a schematic view of a propagation simulator 112 that may be used with an example testing system described herein.

As seen in the example shown in FIG. 4, the propagation simulator 112 includes three propagation channels 136 corresponding to the 3×3 MIMO implementation discussed above by way of example. Each propagation channel 136 includes one or more attenuators 138 and one or more phase shifters 140 connected in series as shown. Each channel of the propagation simulator 112, in the example shown, includes a digital attenuators 138 and a digital phase shifter 140 connected in series. In the example shown, the digital attenuator provides 0-60 dB of attenuation, and the phase shift provides 0-360° of phase shift. Instead of one digital attenuator providing 0-60 dB of attenuation for each channel, the propagation simulator 112, for example, may alternatively include two digital attenuators connected in series each providing 0-30 dB of attenuation for each channel. Other alternative arrangements may also selectively be employed.

The digital attenuators 138 and phase shifters 140 are designed to simulate, in a lab environment, propagation scenarios that may occur in the field, such as an open air office environment. Accordingly, the propagation simulator 112 may be used to simulate various attenuation conditions in order to test the communication between a wireless device and a wireless access device. Those skilled in the art will understand that attenuation (also referred to as path loss) relates to the reduction in power density of a signal as the signal propagates through space.

Attenuation may occur as a result of free-space path loss, refraction, diffraction, reflection, absorption, and various environmental factors such as terrain, obstructions, and conditions of the air. The propagation simulator 112 enables an operator to simulate these path loss effects by manipulating the attenuators 138 and the phase shifters 140 of the simulator. As discussed above, interface cables 113 may be connected to a serial port (not shown) and the propagation simulator 112 thus coupling the propagation simulator 112 to an external computing device. An operator may specify values for the attenuators 138 and the phase shifters 140 at the external computing device and transmit the specified values to the propagation simulator 112. Thus, an operator may simulate various propagation scenarios and determine how the communication between a wireless device and a wireless access device is affected in particular propagation scenarios.

Attenuation between the wireless access device 102 and the unit under test 108 may then be translated to a distance range corresponding to a similar attenuation or propagation loss. For example, an attenuation of 30 dB, under certain circumstances, may correspond to a distance of 60 feet from the wireless access device, and an attenuation of 10 dB may correspond to a distance of 20 feet from the access device. Attenuation may be translated to range using a lookup table or an appropriate curve-fit formula.

To determine the attenuation between the chambers 106a-b of the testing system 100. An example propagation loss formula may include the following values:

TABLE 1
Attenuation Values

| Value | Description |
|---|---|
| A | total attenuation (dB) between the chambers |
| C₁ | coupling (dB) between the wireless access device and the |
| | probe antennas for the wireless access device |
| G₁ | gain (dB) of the probe antennas for the wireless access device |
| L₁ | insertion loss (dB) through the cable from the probe |
| | antennas for the wireless access device |
| L_{A} | insertion loss (dB) and the attenuation of the digital attenuator |
| L_{P} | insertion loss (dB) through the digital phase shifter |
| L₂ | insertion loss (dB) through the cable from the probe |
| | antennas for the unit under test |
| G₂ | gain (dB) of the probe antennas for the unit under test |
| C₂ | coupling (dB) between the unit under test and the probe |
| | antennas for the unit under test |

Attenuation may be calculated by adding the coupling and gain between the probes and the devices and then subtracting the insertion loss that occurs through the coaxial cables and the propagation simulator. An example propagation loss formula may be:

A=C₁+G₁−L₁−L_{A}−L_{P}−L₂+G₂+C₂

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that a certain of the details described herein can be varied considerably without departing from the basic principles of the invention.

What is claimed is:

1. An apparatus for testing the communication between a wireless access device and a wireless device in communication with the wireless access device, the apparatus comprising:
a housing comprising a first interior chamber adapted to receive a wireless access device and a second interior chamber adapted to receive a wireless device;
a simulator device for simulating one or more propagation scenarios between the wireless access device and the wireless device;
a first plurality of probes positioned in the first interior chamber and coupled to the simulator device;
a second plurality of probes positioned in the second interior chamber and coupled to the simulator device; and
wherein the first plurality of probes and the second plurality of probes are adapted to exchange signals between the wireless access device and the wireless device.

2. The apparatus of claim 1 wherein each probe of the first plurality of probes is coupled to a corresponding probe in the second plurality of probes.

3. The apparatus of claim 2 wherein the first plurality of probes and the second plurality of probes are configured as a 3×3 multiple-in/multiple-out (MIMO) wireless system.

4. The apparatus of claim 1 wherein the simulator device propagates the signals exchanged between the wireless access device and the wireless device.

5. The apparatus of claim 1 wherein the first plurality of probes are adjustably positioned adjacent to a top wall of the first interior chamber and wherein the second plurality of probes are adjustably positioned adjacent to a top wall of the second interior chamber.

6. The apparatus of claim 1 wherein the first plurality of probes are positioned towards a central region of the first interior chamber and wherein the second plurality of probes are positioned towards a central region of the second interior chamber.

7. The apparatus of claim 1 further comprising a third interior chamber for placement of the simulator device between the first interior chamber and the second interior chamber and wherein the first interior chamber is positioned below the second interior chamber.

8. The apparatus of claim 1 further comprising:
a first door for providing access to the first interior chamber; and
a second door for providing access to a second interior chamber.

9. The apparatus of claim 8 further comprising:
a first gasket attached to a frame of the first door;
a second gasket attached to the frame of a second door; and
wherein the first gasket and the second gasket are adapted to respectively shield the first interior chamber and the second interior chamber from electromagnetic interference external to the first interior chamber and the second interior chamber.

10. The apparatus of claim 1 further comprising:
a plurality of first interior walls surrounding the first interior chamber;
a first signal absorber attached to at least one of the first interior walls;
a plurality of second interior walls surrounding the second interior chamber; and
a second signal absorber attached to at least one of the second interior walls.

11. The apparatus of claim 10 wherein the first signal absorber and the second signal absorber are each a conductive foam layer attached to each of the interior walls of the first interior chamber and the second interior chamber.

12. The apparatus of claim 1 further comprising a mounting fixture adapted to support the wireless access device in the first interior chamber.

13. The apparatus of claim 1 wherein the simulator device is adapted to simulate attenuation between the wireless access device and the wireless device.

14. The apparatus of claim 13 wherein the simulator device comprises a plurality of transmission channels for propagating signals between corresponding probes of the first plurality of probes and the second plurality of probes.

15. The apparatus of claim 14 wherein the plurality of channels each comprise an attenuator and a phase shifter.

16. The apparatus of claim 15 wherein the attenuator and the phase shifter are arranged in series.

17. The apparatus of claim 15 wherein the attenuator is adapted to receive a control signal identifying an attenuation value for the attenuator and wherein the phase shifter is adapted to receive a control signal identifying a phase shift value for the phase shifter.

18. The apparatus of claim 15 wherein the attenuator is adapted to provide up to approximately 60 decibels (dB) of attenuation and wherein the phase shifter is adapted to provide up to approximately 360° of phase shift.

19. The apparatus of claim 1 wherein the probe is dual-polarized for receipt of polarized signals.

20. The apparatus of claim 19 wherein the probe is adapted to operate in the WiFi frequency bands.

21. The apparatus of claim 20 wherein the probe comprises:
a first antenna;
a second antenna; and
wherein the first antenna is interleaved with and positioned orthogonally to the second antenna.

22. The apparatus of claim 21 wherein the first antenna and the second antenna of the probe are each a patch antenna.

23. The apparatus of claim 22 wherein the probe is adapted to operate substantially between the 1.5 GHz frequency band and the 8 GHz frequency band.

24. The apparatus of claim 23 wherein the first antenna and the second antenna of the probe each comprise a first radiating section adapted to interface with IEEE standard 802.11b or 802.11g radio modules and a second radiating section adapted to interface with IEEE standard 802.11a radio modules.

25. The apparatus of claim 24 wherein the first radiating section comprises a spiraled antenna arm and the second radiating section comprises a tapered slot.

26. The apparatus of claim 21 further comprising a power combiner coupled between the first antenna and the second antenna for combining the signals received at the first antenna and the second antenna.

27. The apparatus of claim 26 wherein the power combiner is printed on a circuit board of at least one of the first antenna and the second antenna.

28. The apparatus of claim 19 wherein the first plurality of probes and the second plurality of probes are adapted to be adjusted until a maximum signal strength from the wireless access device and the wireless device is respectively determined.

29. A method of testing the communication between a wireless access device and a wireless device in communication with the wireless access device comprising:
placing a wireless access device into a first interior chamber of a housing and adjacent to a first plurality of probes adapted to exchange signals with the wireless access device;
placing a wireless device into a second interior chamber of the housing and adjacent to a second plurality of probes adapted to exchange signals with the wireless device;
simulating a propagation scenario when signals are exchanged between the wireless access device and the wireless device.

30. The method of claim 29 further comprising coupling each probe of the first plurality of probes to a corresponding probe in the second plurality of probes.

31. The method of claim 30 further comprising configuring the first plurality of probes and the second plurality of probes as a 3×3 multiple-in/multiple-out (MIMO) wireless system

32. The method of claim 30 further comprising coupling the first plurality of probes and the second plurality of probes to a simulator device for simulating the propagation scenario.

33. The method of claim 32 further comprising coupling each of the first plurality of probes and the second plurality of probes to a corresponding transmission channel of the simulator device.

34. The method of claim 33 wherein each transmission channel comprises an attenuator and a phase shifter, the method further comprising adjusting the attenuator and the phase shifter to simulate the propagation scenario.

35. The method of claim 34 further comprising sending a control signal to at least one of the attenuator and the phase shifter identifying at least one of an attenuation value for the attenuator and a phase shift value for the phase shifter.

36. The method of claim 34 wherein the attenuator and the phase shifter of each transmission channel of the simulator device are arranged in series.
